(19) United States
(12) Patent Application Publication
(10) Pub. No.: US 2015/0206516 A1
(43) Pub. Date: Jul. 23, 2015

(54) Pick For Stringed Musical Instruments

(71) Applicant: Jonathan Mark Thompson, Lake Forest, CA (US)

(72) Inventor: Jonathan Mark Thompson, Lake Forest, CA (US)

(21) Appl. No.: 14/600,087

(22) Filed: Jan. 20, 2015

Related U.S. Application Data
(60) Provisional application No. 61/930,605, filed on Jan. 23, 2014.

(51) Int. Cl. G10D 3/16

(52) U.S. Cl. CPC G10D 3/163

(57) ABSTRACT

A pick for use with stringed musical instruments is disclosed. In some embodiments the pick is characterized by a roughened texture on the front and back substantially planar surfaces of the narrowed bottom portion of a substantially teardrop shaped body for the purpose of altering the tonal properties produced as it moves against strings that are strummed or picked. In further embodiments the roughened textured picking portion is combined with a separate second picking portion that is substantially smooth and useable to produce a conventional sound.

### FIELD OF THE INVENTION

The present invention relates generally to picks for stringed musical instruments. More particularly, the invention relates to stringed musical instrument picks that alter the tonal properties produced when the strings are strummed or picked.

### BACKGROUND OF THE INVENTION

Musicians use a pick to pluck or strum the strings of a stringed musical instrument thereby causing them to vibrate and produce musical sounds and tones. A typical instrument pick is a small substantially teardrop shaped object having a broadened top finger grip portion and a narrowed bottom picking portion. In use, a musician holds the broadened top portion between the thumb and forefinger to guide the narrowed picking portion across the strings.

Picks of the prior art are substantially smooth on the front and back planar surfaces of the narrowed bottom portion so that they are nearly frictionless and soundless as they slide across the strings during strumming or plucking. Some picks of the prior art have a roughened textured on the broadened top finger grip portion to increase the gripping friction between the pick, thumb, and forefinger thereby making it less likely for the pick to be dropped unintentionally during use.

Frequently it is desirable for musicians to produce a number of differentiated tonal sounds in a single performance. By way of example, a musician may prefer to have a quiet subdued tone while playing behind a vocalist and a louder or more distorted tone during an instrument solo. The final perceived tonal sound is typically the summation of several tone altering apparatuses or selected features. Some examples include but are not limited to: engaging or disengaging electronic circuitry designed to distort or otherwise modify the electric signal of a stringed instrument's pickups, the type of amplifier used, the dimensions and material of the instrument body and strings, and the dimensions and material of the instrument pick.

In view of the foregoing there is a need for an improved design for a stringed musical instrument pick. For example it may be desirable for an improved pick to impart gritty or distorted tonal properties by nature of its design. It would be further desirable to be able to change the tonal properties imparted by the pick during a performance. Further still it would be desirable to include a means of changing the tonal properties quickly so as to not interrupt or delay the performance.

### SUMMARY OF THE INVENTION

To achieve the foregoing and other objects in accordance with the purpose of the present invention, a variety of features are described to achieve a pick for stringed musical instruments.

A pick for use with stringed musical instruments is disclosed. In some embodiments the pick is characterized by a roughened texture on the front and back substantially planar surfaces of the narrowed bottom portion of a substantially teardrop shaped body for the purpose of altering the tonal properties produced as it moves against strings that are strummed or plucked. In further embodiments the roughened textured picking portion is combined with a separate second picking portion that is substantially smooth and useable to produce a conventional sound. In still further embodiments a series of ridges radially protruding from a mutually opposing third portion is included as a means of quickly changing between the aforementioned roughened texture picking portion and substantially smooth picking portion.

These embodiments and other features, objects, and advantages will become more fully apparent and more easily understood from the following detailed descriptions, which should be reviewed in conjunction with the provided drawings.

### BRIEF DESCRIPTION OF THE DRAWINGS

The present invention is illustrated by way of example, and not by way of limitation, in the figures of the accompanying drawings where:

FIG. 1 is a perspective view of a first instrument pick having features of the invention;

FIG. 2 is a side view of the instrument pick illustrated in FIG. 1;

FIG. 3 is a side view of a pick having features of the invention striking the strings of a stringed musical instrument.

FIG. 4 is a front view of a second instrument pick having features of the invention.

FIG. 5 is a front view of the instrument pick illustrated in FIG. 4, rotated to illustrate how a musician could orientate the pick to use the second narrowed picking portion.

FIG. 6 is front view of a third instrument pick having features of the invention.

### DETAILED DESCRIPTION OF THE EMBODIMENTS

Embodiments of the invention are described in following text with reference to the Figures. However, those skilled in the art will readily appreciate that this description is for illustrative purpose and the invention extends beyond dimensions, patterns, and shapes described in these limited embodiments.

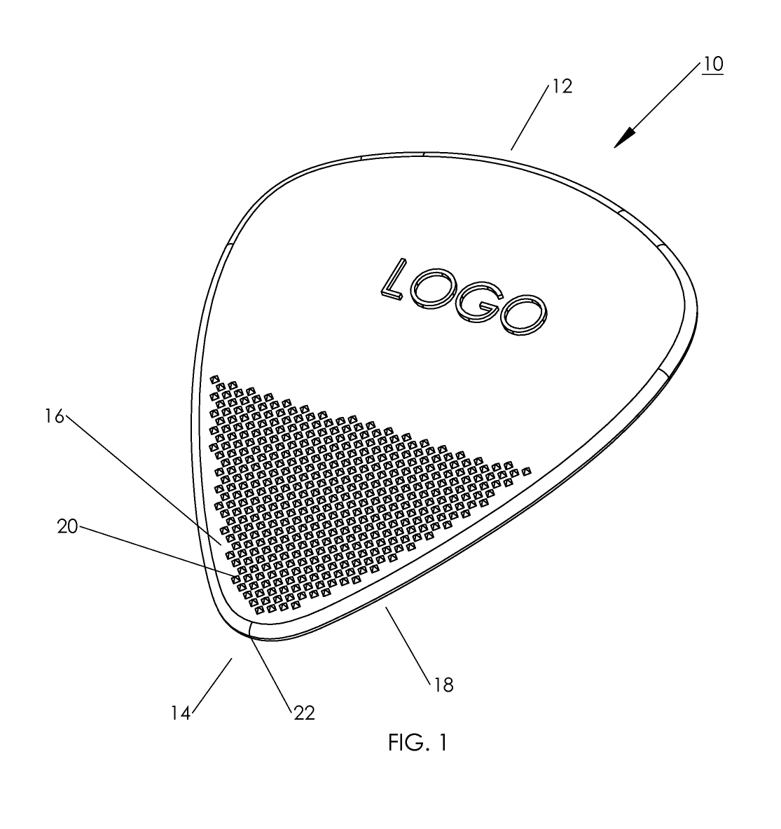

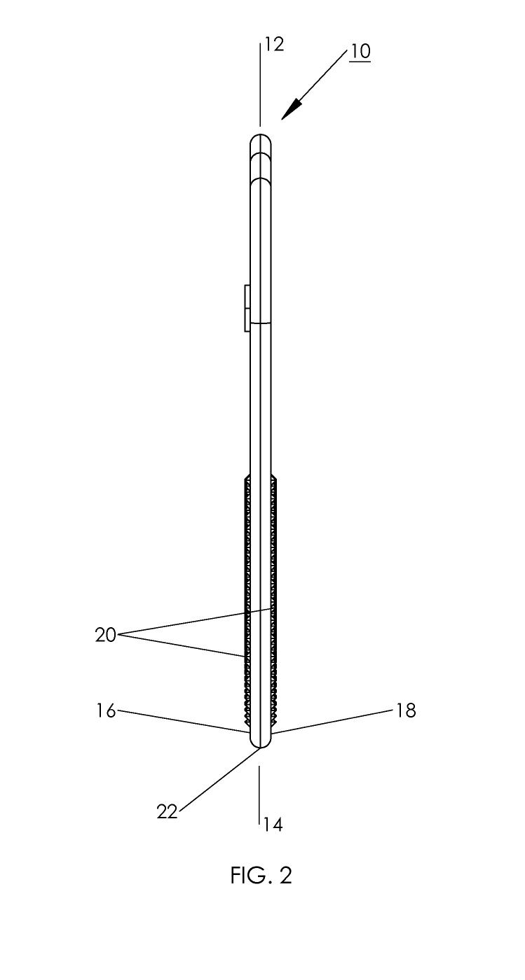

The invention is a pick 10 suitable for strumming or plucking the strings of a stringed musical instrument. FIGS. 1 and 2 show by way of example a teardrop shaped pick 10 with a broadened upper finger hold portion 12 and a narrowed lower picking portion 14. The narrowed lower picking portion 14 makes up approximately half the length of the entire pick 10. The upper finger hold portion 12 makes up the remaining approximate half of the length of the entire pick 10. The lower narrowed picking portion 14 has front and rear opposing faces 16, 18 which are characterized by a roughened texture 20.

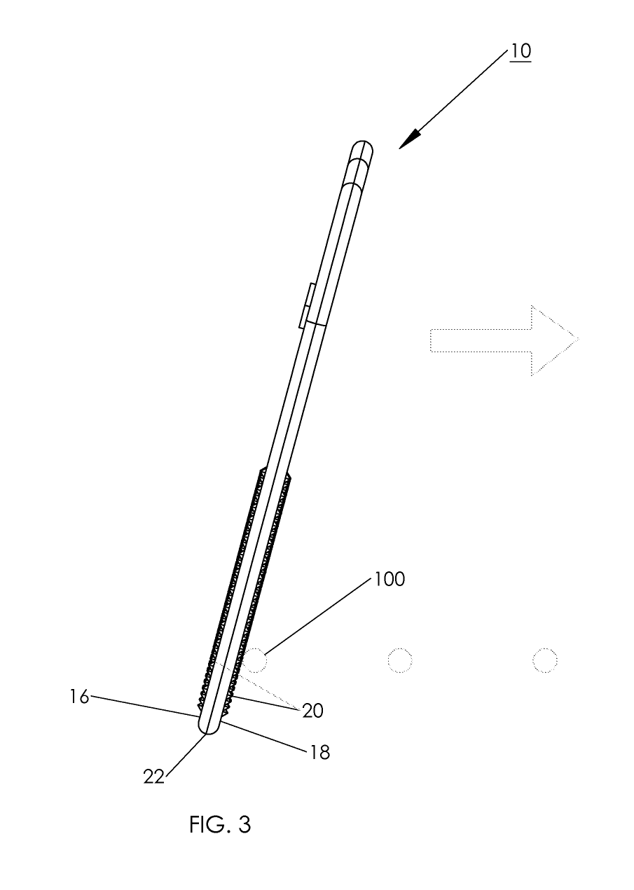

In use, the roughened texture 20 of the front and rear faces 16, 18 makes contact with the string 100 of a stringed musical instrument during strumming or plucking as illustrated in FIG. 3. As the roughened texture 20 moves across the string 100 it produces a “raspy” or “gritty” timbre which is both pleasant and novel. When the roughened texture 20 portion of the pick has moved sufficiently far along the string 100 so as to reach its endmost tip 22 the string is released to vibrate freely thereby producing a final resulting musical sound or tone.

In the prior art, any front and rear surfaces in the lower narrowed picking portion are substantially smooth and thereby are nearly frictionless and soundless as they move across the strings.

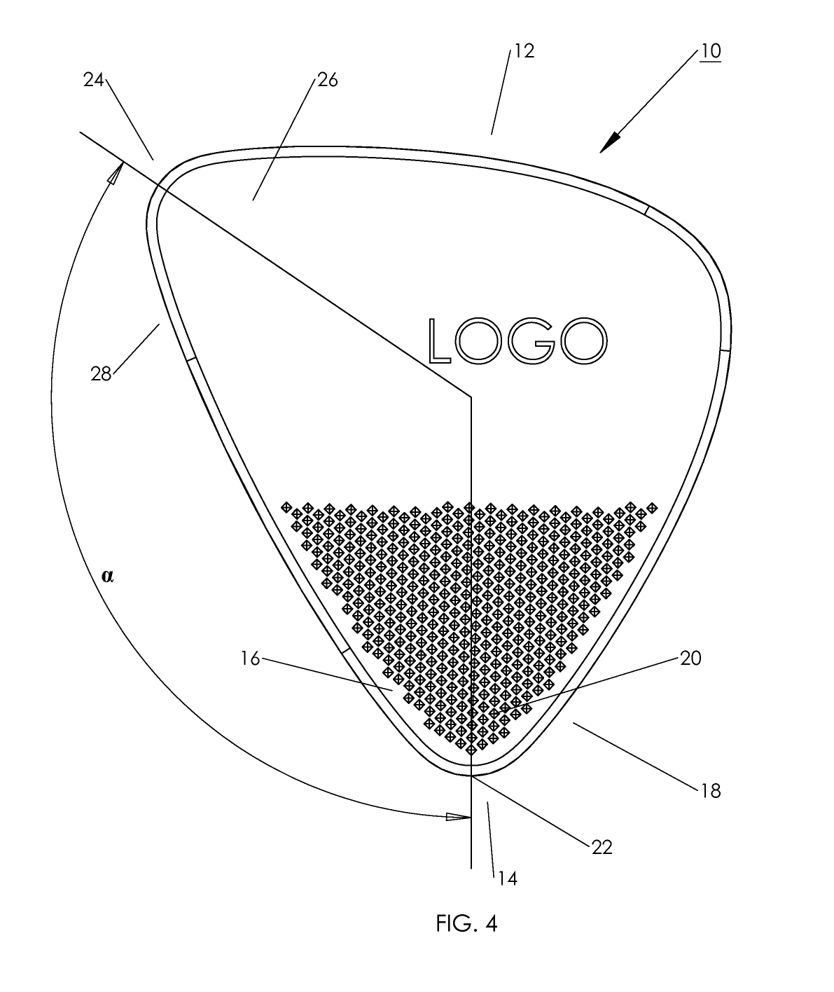

FIG. 4 illustrates a pick constructed in accordance with another embodiment of the invention. The body of the pick includes the profile of a second narrowed picking portion 24 that is angularly disposed relative to the adjacent lower textured narrowed picking portion 14. The second narrowed picking portion 24 can be disposed at a variety of angles a with respect to the lower narrowed picking portion 14. Typically the second narrowed picking portion 24 is disposed between 40 and 180 degrees with respect to the lower narrowed picking portion 14.

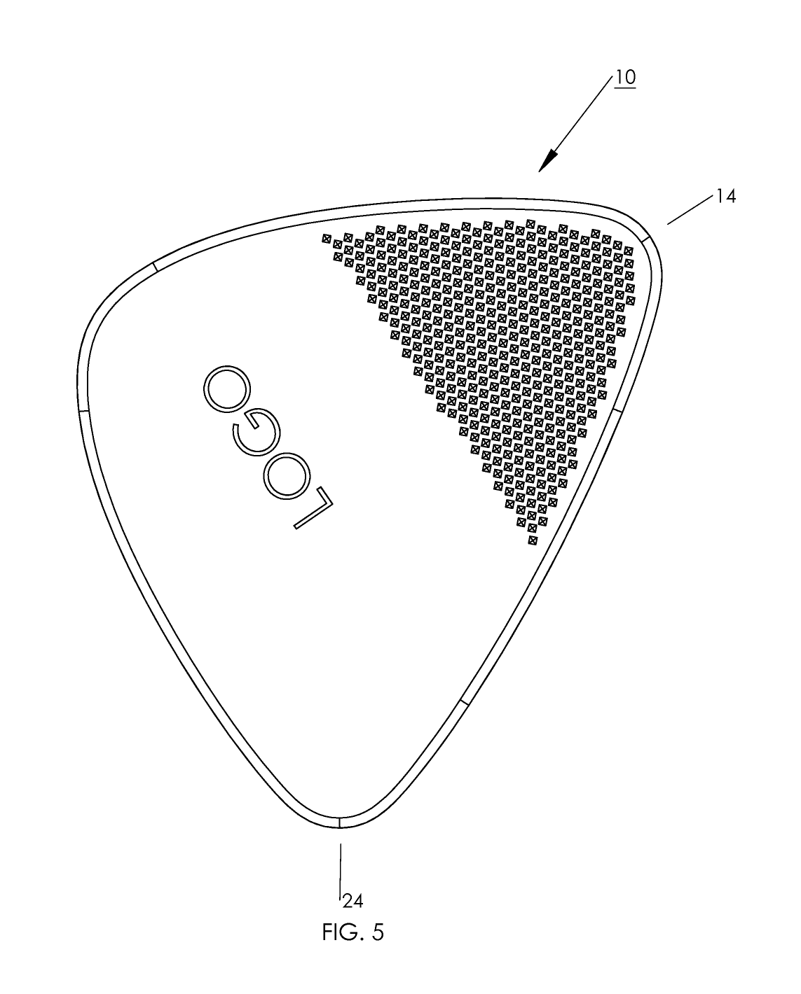

The second narrowed picking portion 24 is substantially smooth on its front and rear surfaces 26, 28. In use, the musician can use the roughened texture narrowed portion 14 of the pick to produce a unique “gritty” timbre as described above, or rotate the pick to strum or pluck the strings with the second smooth narrowed portion 24 to produce a conventional sound. FIG. 5 shows by way of illustration the pick of FIG. 4 rotated so that the second narrowed picking portion 24 is in position for use by the musician.

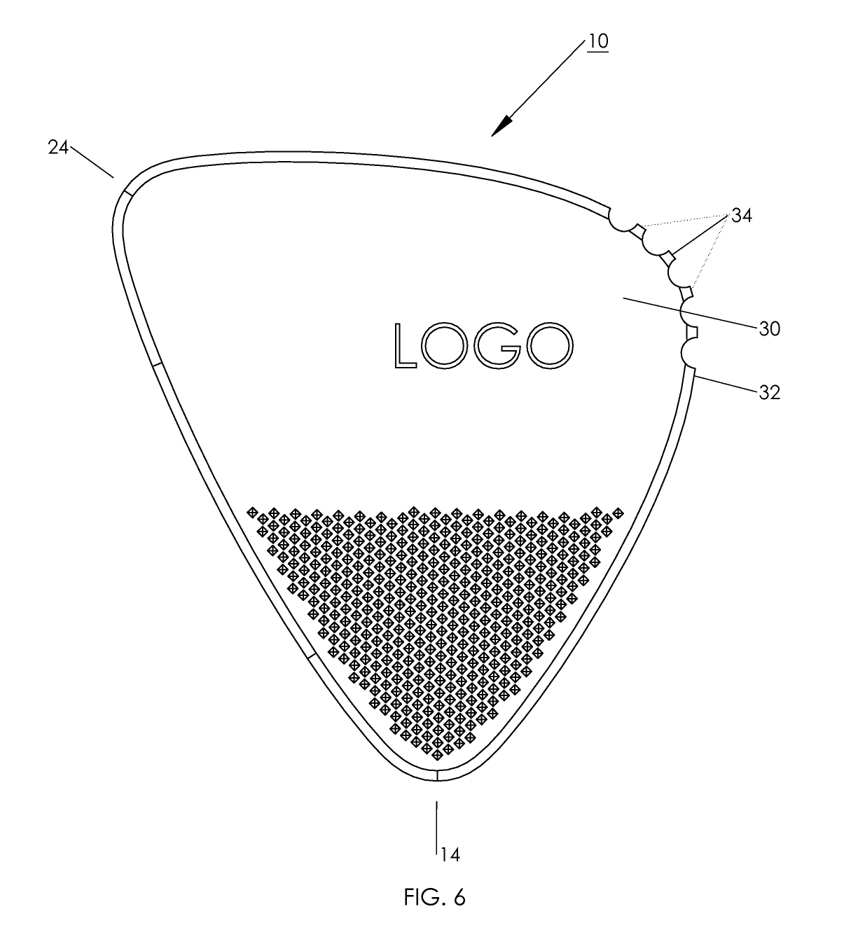

In another embodiment of the invention, as illustrated in FIG. 6, the body of the pick has a mutually opposing third portion 30 with an arced outer profile 32. The arced outer profile has ridges 34 formed by radially protruding peaks and valleys. The ridges 34 form a tactile means of rotating the pick quickly when selecting between the textured narrowed picking portion 14 and the smooth narrowed picking portion 24. Depending on how the musician holds the instrument pick, he or she could press the pad of his or her index finger to the ridges 34 thereby rotating the pick quickly between the thumb and middle finger. Additionally, the ridges 34 provide a tactile reference to the musician to distinguish which of the narrowed picking portions is currently in use.

The invention has been described above by way of illustration, and the specific embodiments disclosed are not intended to limit the invention to the exact construction and operation shown and described. It is to be noted that other equivalents or substitutions will occur to those skilled in the art without departing from the spirit and scope of the present invention as described in the claims. For example, the roughened textured surface 20 could be achieved by a formation of any conceivable shape, pattern, or dimension, both random or geometric, both integrated or adhered or formed in a post process, and still fall within the scope of the present invention.

What is claimed:

1. A pick for use with stringed musical instruments comprising:
a. A substantially teardrop shaped body with a broadened upper finger grip portion and a narrowed lower picking portion; and
b. Said narrowed lower picking portion has substantially planar front and back sides characterized by a roughened texture;

2. The pick of claim 1, wherein the roughened texture engages the strings of a stringed musical instrument as they are strummed or plucked and thereby alters the tonal properties produced by said instrument.

3. The pick of claim 1, wherein the roughened texture consists of a repeating geometric pattern.

4. The pick of claim 1, wherein the roughened texture consists of a random pattern.

5. The pick of claim 1, wherein the profile of a second narrowed picking portion is angularly disposed relative to the adjacent lower narrowed picking portion.

6. The pick of claim 5, wherein the angular disposition of the second picking portion is between 40 and 180 degrees relative to the adjacent lower picking portion.

7. The pick of claim 5, wherein the second picking portion is smooth and useable to produce a conventional sound.

8. The pick of claim 5, wherein there is a mutually opposing third portion with an arced outer profile.

9. The pick of claim 8, wherein said arced outer profile has ridges formed by radially protruding peaks and valleys.
